(19) United States
(12) Patent Application Publication
(10) Pub. No.: US 2020/0113016 A1
(43) Pub. Date: Apr. 9, 2020

(54) CPRI/eCPRI Data Transmission Method in Cloud Radio Access Network

(71) Applicant: DIGIMETRIK LLC, Reston, VA (US)

(72) Inventor: VOLKAN SEVINDIK, Reston, VA (US)

(73) Assignee: DIGIMETRIK LLC, Reston, VA (US)

(21) Appl. No.: 16/591,587

(22) Filed: Oct. 2, 2019

Related U.S. Application Data
(60) Provisional application No. 62/766,207, filed on Oct. 5, 2018.

(51) Int. Cl. H04W 88/08

(52) U.S. Cl. CPC H04W 88/085; H04W 92/12

(57) ABSTRACT

A method of communicating between a cloud base band unit and a plurality of remote radio heads including Common Public Radio Interface (CPRI) link, Ethernet/Enhanced/Evolved Common Public Radio Interface (eCPRI), CPRI repeater, eCPRI repeater, CPRI router, eCPRI router, CPRI layer bridge, and eCPRI layer bridge. The communication method involves changing the CPRI and eCPRI layer split based on the CPRI and eCPRI link capacity, changing layer split based on remote radio head (RRH) layer split capability, and changing the CPRI signal and the eCPRI data packet route based on the RRH load.

### CROSS-REFERENCE TO A RELATED APPLICATION

This application claims the benefit of U.S. Provisional Application Ser. No. 62/766,207 filed on Oct. 5, 2018 the disclosure of which is hereby incorporated by reference in its entirety, including all figures, tables and drawings.

### BACKGROUND OF THE INVENTION

Cloud Radio Access Network (CRAN) is a technology that has all base band units in the central location in the data center, and/or any central location. CRAN hosts all processing for all layers of the targeted communication technology. CRAN runs all of the base station functions, software protocol stacks, protocol layers, and software functionality in the cloud. A Common Public Radio Interface (CPRI) is a communication standard used to send information from a CRAN to Remote Radio Heads (RRH). CPRI aggregator hosts at least one CPRI communication module in the CRAN. Fronthaul connections transmit signals from the CRAN to the CPRI. The primary issue with CRAN is the Fronthaul link's capacity because a CRAN typically serves more than one RRH. There must be sufficient Fronthaul capacity to send and to receive all data signals. In addition, as some traffic types have latency requirements, data needs to be sent with a pre-defined maximum delay value. There is a need for Fronthaul links that satisfy these data transmission latency requirements.

### BRIEF SUMMARY OF THE INVENTION

An embodiment of the invention is directed to a method of communicating between a base band cloud unit and a plurality of remote radio heads, comprising steps of transmitting a signal packet and a data packet from the base band cloud unit to at least one remote radio head through at least one digital radio interface, sending an output of one of a least one layer of processing depending on a digital radio interface capacity and a digital radio interface latency performance, sending the signal packet and the data packet from the base band cloud to at least one of the at least one remote radio heads through the digital radio interface with a digital radio interface repeater, sending the signal packet and the data packet from the base band cloud to at least one of the at least one remote radio heads through the digital radio interface with the digital radio interface router and sending the signal packet and the data packet from the base band cloud to at least one of the at least one remote radio heads through the digital radio interface with the digital radio interface layer bridge. The digital radio interface is at least one of a Common Public Radio Interface (“CPRI”) and an Ethernet Common Public Radio Interface (“eCPRI”). The signal packet is Common Public Radio Interface (“CPRI”) signal packet. The data packet is Ethernet Common Public Radio Interface (“eCPRI”) data packet. Sending the output of different layers of processing includes measuring at least one or a CPRI link capacity and an eCPRI link capacity, measuring a signal round trip delay of at least one of CPRI link and eCPRI link, and determining which of the output of different layers of processing is sent through the at least one of the CPRI interface and the eCPRI interface. Determining which of the output of the different layers of processing involves determining at which of the at least one layer of processing a split is performed for determining: which of the output of the at least one layer of processing is used as a final processing layer on a sender's side; how long the split is used, for which of the data packet the split is used, and for which of at least one user the split is used. Measuring a latency of at least one of the CPRI signal packet and the eCPRI data packet with the digital radio interface repeater can employ a CPRI repeater, where if the signal round trip delay of at least one of the eCPRI data packet and the CPRI signal packet is higher than a dynamically determined threshold, the CPRI repeater drops at least one of the CPRI signal packet and eCPRI data packet, and asks for retransmission of at least one of the CPRI signal packet and eCPRI data packet from the at least one of a CPRI signal packet sender and an eCPRI data packet sender. Measuring a latency of at least one of the CPRI signal packet and the eCPRI data packet is performed between the digital radio interface repeater and each of the at least one remote radio head connected to the digital radio interface repeater through any of a direct link and an indirect link, where the digital radio interface repeater is a CPRI repeater. The eCPRI data packet includes data selected from a Starting Time of Transmission, a Layer Split Number, a Remote Radio Head Identifier, an eCPRI data, and any other field. At least one of CPRI signal packet and eCPRI data packet can be sent through at least one of at least one transmission route where the transmission route used depends on a throughput requirement and a delay requirement of a carried traffic inside at least one of CPRI signal and eCPRI data packet, where sending is by the digital radio interface router and where the digital radio interface router is a CPRI router. The digital radio interface router can be a CPRI router that holds a latency (delay) table and a Remote Radio Head (RRH) load information table. The digital radio interface repeater can be a CPRI repeater or an eCPRI repeater and the latency table includes conditions for the CPRI repeaters, the CPRI routers, the eCPRI repeaters, the eCPRI routers where the latency table includes at least one latency value between a split performed at one of the at least one layer of processing for each of the remote radio heads, of the CPRI repeaters, and of the eCPRI repeaters. A remote radio head load information table includes information for the CPRI routers, the eCPRI routers, the remote radio heads, and the load information of the remote radio head is connected to one of the at least one CPRI router and at least one eCPRI router. A split changed between the layer of processing for an incoming of at least one of the CPRI signal packet and the eCPRI data packet in the digital radio interface layer bridge depending on a data capacity (throughput), a data latency of at least one of CPRI link and eCPRI link, a remote radio head processing capability, a remote radio head split capability, wherein the digital radio interface is the CPRI interface or the eCPRI interface. The digital radio interface layer bridge can have a layer split table and wherein the digital radio interface is the CPRI interface or the eCPRI interface. The layer split table has information of at least one of a CPRI router and an eCPRI router, and a layer split capability of the remote radio heads.

In an embodiment of the invention, the method of communicating between a base band cloud unit and a plurality of remote radio heads includes at least one of a CPRI signal/data packet and an eCPRI signal/data packet sent through one or more CPRI repeaters and eCPRI repeaters where repeaters measure at least one of a signal packet latency and a data packet latency or a delay between at least one of the CPRI repeater and the eCPRI repeater and one of at least one of a data processing layer and a signal processing layer of at least one of a receiving CPRI and a receiving eCPRI. A transmission delay is calculated for at least one of a CPRI signal/data packet and an eCPRI signal/data packet through the at least one of CPRI repeater and eCPRI repeater. A split option is checked for the at least one of the CPRI signal/data packet and the eCPRI signal/data packet for the at least one of the data processing layer and the signal processing layers through the at least one of CPRI repeater and eCPRI repeater. The signal and data processing time is sent to each of at least one remote radio head connected to the at least one of CPRI repeater and eCPRI repeater at each of the at least one of the data processing layer and the signal processing layers. A total signal and packet data transmission delay for the at least one of the CPRI repeater and the eCPRI repeater is calculated to determine if the CPRI signal/data packet or the eCPRI signal/data packet is delivered to the remote radio head where the CPRI signal/data packet and the eCPRI signal/data packet is dropped and a request for retransmission of the CPRI signal/data packet and/or the eCPRI signal/data packet by the CPRI repeater and/or the eCPRI repeater occurs if the total signal and data packet transmission delay (latency) is greater than a required data delay (latency). The CPRI signal/data packet and/or the eCPRI data packet is sent from the at least one of the CPRI repeater and the eCPRI repeater to the remote radio head if the total signal and data packet transmission delay (latency) is less than or equal to the required data delay (latency).

An embodiment of the invention is directed to a method of communicating between a base band cloud unit and a plurality of remote radio heads where a CPRI signal/data packet and an eCPRI packet is sent through a CPRI router and an eCPRI router. One of a plurality of processing layer splits is determined for use of the CPRI signal/data packet and the eCPRI data packet in at least one of a CPRI router and an eCPRI router. Which of a plurality of processing layer splits is used for the CPRI signal/data packet and the eCPRI data packet is chosen for delivery to one of at least one remote radio head. A processing layer split table for the CPRI router and eCPRI router is used to determine whether the CPRI signal/data packet and the eCPRI data packet requires revision of the processing layer splits and a processing layer split conversion. Additional time required for CPRI signal/data packet conversion and an eCPRI data packet conversion is determined by the CPRI router and eCPRI router. A comparison of the sum of a transmission time and a remote radio head processing time with a CPRI signal/data packet latency requirement and an eCPRI data packet latency requirement determines requirements of the processing layer split. The CPRI signal/data packet and the eCPRI data packet is transmitted by the CPRI router and the eCPRI router when the sum of transmission time and the remote radio head processing time is less than or equal to the CPRI signal/data packet latency requirement and the eCPRI data packet latency requirement when the processing layer split is not required. The CPRI signal/data packet and the eCPRI data packet are dropped by the CPRI router and/or the eCPRI router when the sum of transmission time and the remote radio head processing time is greater than the CPRI data packet latency requirement and the eCPRI data packet latency requirement when the processing layer split is not required. An available alternate route is determined to satisfy the requirements that the sum of transmission time and the remote radio head processing time is less than, greater than, or equal to the CPRI signal/data packet and the eCPRI data packet transmission latency by the CPRI router and the eCPRI, where: the CPRI signal/data packet and eCPRI data packet is transmitted to the remote radio head selected when the sum of the transmission time and the remote radio head processing time is less than or equal to the CPRI signal/data packet latency and the eCPRI data packet latency; and drops the CPRI signal/data packet and eCPRI data packet when the sum of the transmission time and the remote radio head processing time is greater than the CPRI signal/data packet latency and/or the eCPRI data packet latency. The CPRI signal/data packet latency and the eCPRI data packet latency are measured by the CPRI router and/or the eCPRI router transmitting and at least one of data processing layers and signal processing layers of a receiving CPRI and/or a receiving eCPRI depends on the processing layer splits. The CPRI signal/data packet and the eCPRI data packet transmission time is determined by the CPRI router and/or the eCPRI router to at least one of the remote radio heads connected to the CPRI router and the eCPRI router. The CPRI signal/data packet and the eCPRI data packet are transmitted by the CPRI and the eCPRI router if the sum of total of transmission time, a processing layer split conversion time, and the remote radio head processing time is less than or equal to the CPRI signal/data packet latency and the eCPRI packet data transmission latency. The CPRI signal/data packet and the eCPRI data packet are dropped by the CPRI and the eCPRI router when the sum of total of transmission time and the processing layer split conversion time and the remote radio head processing time is greater than the CPRI signal/data packet latency requirement and the eCPRI packet data latency requirement

### BRIEF DESCRIPTION OF THE DRAWINGS

FIG. 1 shows a Cloud Radio Access Network CRAN connected to core network through backhaul part and remote radio heads (RRHs).

FIG. 2 shows CRAN that transmits data to remote radio heads using wireless connections.

FIG. 3 shows a CPRI aggregator to aggregate functionalities of more than one CPRI communication module.

FIG. 4 shows hardware for implementation of a CPRI standard.

FIG. 5 shows CPRI module software for running CPRI module hardware.

FIG. 6 shows a Remote Radio Head connected to CRAN through a fronthaul connection, according to an embodiment of the invention.

FIG. 7 shows a representation of dynamic functions addressed in a CPRI layer process using a layer split architecture, according to an embodiment of the invention.

FIG. 8 shows a Remote Radio Head connected to CRAN through a fronthaul connection employing a CPRI repeater, according to an embodiment of the invention.

FIG. 9 shows a Remote Radio Head connected to CRAN through a fronthaul connection employing a CPRI router, according to an embodiment of the invention.

FIG. 10 shows a Remote Radio Head connected to CRAN through a fronthaul connection employing a CPRI layer bridge, according to an embodiment of the invention

FIG. 11 shows transmission when a data transmission latency requirement is not met where a sender CPRI/eCPRI moves one more layer and outputs to a receiving CPRI/eCPRI and to a RRH, according to an embodiment of the invention.

FIG. 12 shows transmission when a data transmission latency requirement is not met where after reception from a RRH, a sender CPRI/eCPRI moves one more layer and outputs to a receiving CPRI/eCPRI, according to an embodiment of the invention.

FIG. 13 shows CRAN processing layers and where a CPRI/eCPRI layer falls into the CRAN architecture with direct communication between a CPRI/eCPRI and MAC layer 704, according to an embodiment of the invention.

FIG. 14 shows eCPRI packet parameters employed created at different processing layers for transmission.

FIG. 15 shows a layer latency table for a CPRI/eCPRI repeater, according to an embodiment of the invention.

FIG. 16 shows a layer latency table for a CPRI/eCPRI router, according to an embodiment of the invention.

FIG. 17 shows a RRH load information table for a CPRI/eCPRI router, according to an embodiment of the invention.

FIG. 18 shows a layer split table to allows eCPRI layer bridge to perform a layer split conversion between protocol layers, according to an embodiment of the invention.

FIG. 19 shows logic schematic for use of the CPRI/eCPRI layer bridge method, according to an embodiment of the invention.

FIG. 20 show a CPRI/eCPRI router operation scheme, according to an embodiment of the invention.

FIG. 21 show a CPRI/eCPRI router operation scheme, according to an embodiment of the invention.

FIG. 22 shows a CPRI/eCPRI repeater on the fronthaul link between RRHs and Cloud Radio Access Networks, according to an embodiment of the invention.

FIG. 23 shows a CPRI/eCPRI router on the fronthaul link between RRHs and Cloud Radio Access Networks, according to an embodiment of the invention.

FIG. 24 shows a CPRI/eCPRI layer bridge on the fronthaul link between RRHs and Cloud Radio Access Networks, according to an embodiment of the invention.

FIG. 25 shows CPRI/eCPRI repeaters to transmit CPRI/eCPRI data packets to at least one of the RRHs coming from at least one of Cloud Radio Access Network using a fronthaul connection, according to an embodiment of the invention.

FIG. 26 shows CPRI/eCPRI routers to transmit CPRI/eCPRI data packets to at least one of the RRHs coming from at least one of Cloud Radio Access Network using a fronthaul connection, according to an embodiment of the invention.

FIG. 27 shows CPRI/eCPRI layer bridge to transmit CPRI/eCPRI data packets to at least one of the RRHs coming from at least one of Cloud Radio Access Network using a fronthaul connection, according to an embodiment of the invention.

FIG. 28 shows RRH hardware employed in the CRAN according to an embodiment of the invention.

FIG. 29 shows RRH software employed in the CRAN according to an embodiment of the invention.

FIG. 30 shows a representation of dynamic functions addressed in a CPRI/eCPRI layer process using a layer split architecture, with a data transmission latency requirement not met where a sender CPRI/eCPRI moves one more layer, according to an embodiment of the invention.

FIG. 31 show a CPRI/eCPRI repeater operation scheme, according to an embodiment of the invention.

### DETAILED DESCRIPTION OF THE INVENTION

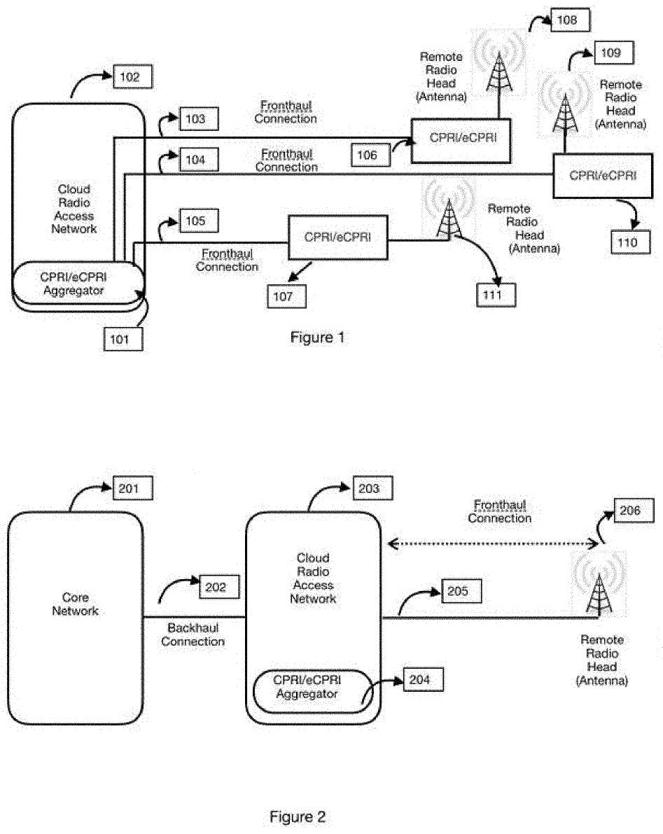

As shown in FIG. 1, Cloud Radio Access Network CRAN 102 is connected to core network through backhaul part, and the CRAN is connected to remote radio heads (RRHs) 108, 109, and 111 through fronthaul part. A Fronthaul is the communication link between CRAN and one or more remote radio head. Fronthaul link 103, 104, and 105 connect CRAN 102 with remote radio heads 108, 109, and 111. A Backhaul is the communication link between CRAN and core network.

Fronthaul connections 103, 104, 105, 809, 810, and 806, as shown in FIGS. 1 and 2, can be wired or wireless connections or both. FIG. 2 shows that CRAN transmits data to at least one of remote radio head 816, 824, and 825 using wireless connection.

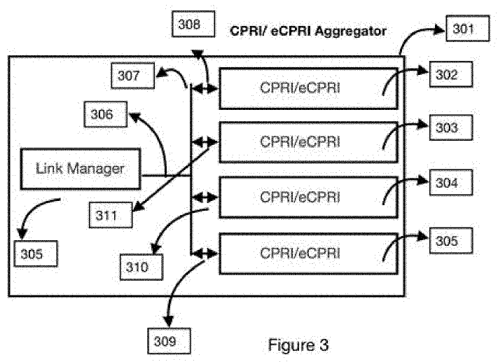

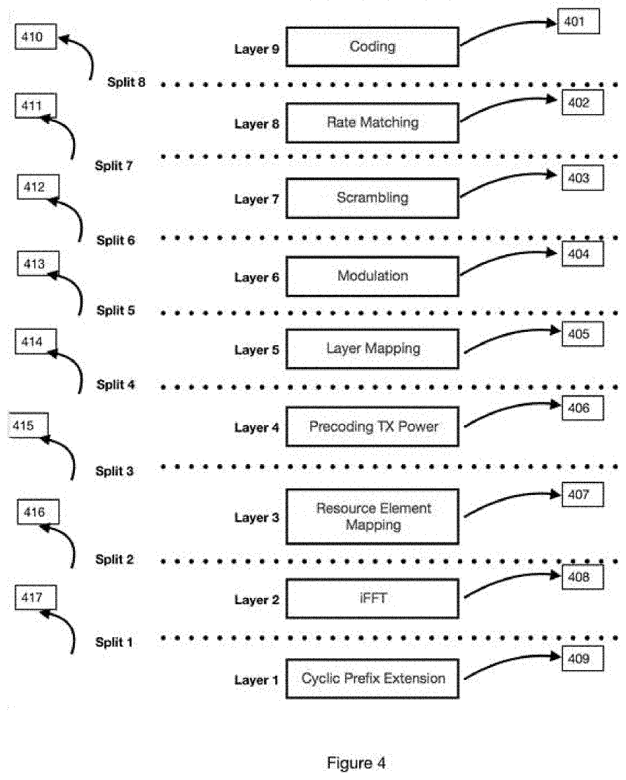

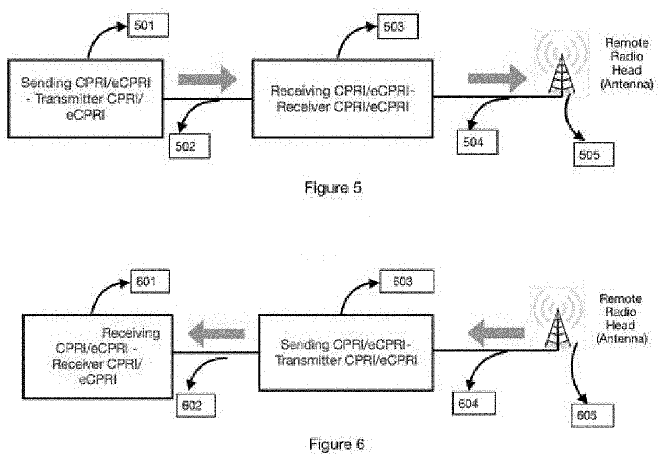

CPRI aggregators 101 and 301, as shown in FIGS. 1 and 3, aggregate the functionalities of more than one CPRI communication module, eCPRI aggregators 101 and 301 aggregate the functionalities of more than one eCPRI communication module. eCPRI is the standard used to send eCPRI data packets from CRAN to RRH. CPRI and eCPRI communication standards are used to transmit data in fronthaul. A CPRI standard can be implemented in a separate hardware, FIG. 4. The CPRI hardware consists of at least one of processor, 2010, central processor unit (CPU), 2010, central processor, 2010, memory unit, 2011, field programmable gateway array (FPGA), 2007, ethernet port, 2012, digital signal processor, 2008, graphical processing unit (GPU), 2009, controller, 2004, antennas, 2005, optical port, 2006, electrical to optical conversion, 2001, optical to electrical conversion, 2002, artificial intelligence processor, 2003, currency & value wallet, 2013, smart contract hardware, 2014, mining hardware, 2015, and blockchain hardware, 2016. CPRI module software runs on CPRI module hardware. CPRI module software, FIG. 5, consists of at least one of operating system software, 3001, ethernet port data transmission and reception software, 3002, optical port data transmission and reception software, 3003, optical to electrical data conversion software, 3004, ethernet port management software, 3005, protocol conversion software, 3006, electrical to optical data conversion software, 3007, radio frequency data processing software, 3008, graphical data processing software, 3009, optical port management software, 3010, data processing software, 3011, digital signal processing software, 3012, artificial intelligence software, 3013, database, 3014, digital wallet software, 3015, mining software, 3016, and smart contract & blockchain software, 3017.

CPRI communication module 106 or eCPRI communication module 107 sends at least one of electrical and/or optic signals, as indicated in FIG. 1. For electrical signals, existing or new ethernet connections are used. For optic signals, existing or new fiber connections are used. Each CPRI 302, 303, 304, and 305 and each eCPRI 302, 303, 304, and 305 sends data to at least one of Remote Radio Heads connected to CRAN 102 and 203, as shown in FIGS. 1 and 6. CPRI signal, CPRI electric signal, CPRI optical signal, CPRI optical packet, CPRI packet, and CPRI data packet are equivalent terms that are used interchangeably in this disclosure. The terms eCPRI signal, eCPRI electric signal, eCPRI optical signal, eCPRI optical packet, eCPRI packet, and eCPRI data packet are equivalent and are used interchangeably in this disclosure. CPRI/eCPRI communication module is a transceiver device which sends and receives CPRI/eCPRI data packet simultaneously. CPRI/eCPRI communication module has software, 3014, 3015, 3016, and 3017, of FIG. 5 and hardware, 2013, 2014, 2015, and 2016 of FIG. 4 components to initiate, save, execute, and revoke any kind of smart contract with any other components including other CPRI/eCPRI communication module. A CPRI/eCPRI communication module has software and hardware components to create, mine, send, and receive any transaction in the network. This transaction is at least one of cryptocurrency, information, information ledgers, performance ledgers, charging ledgers, or communication ledgers.

When one CPRI module or eCPRI module has capacity available to serve another remote radio head, capacity of this CPRI/eCPRI module is used to transfer data to that remote radio head 108, 109, or 111.

CRPI module 101 or 204 in the CRAN 102 or 203, respectively, communicates with CPRI module 106, 107, or 110 on RRH side 108, 109, or 111. One CPRI module 302, 303, 304, or 305 is responsible for transmitting and receiving CPRI data. FIG. 400 shows all CPRI functional layers used to transmit and receive CRPI data.

Link manager 305 in CPRI aggregator 301 communicates with upper processing layers to determine the capacity and latency needs of the traffic that is sent over the fronthaul connection. Link manager 305 has a look up table that defines each traffic type sent, where the traffic type is defined by a traffic index. The same lookup table exists in upper processing layers. Upper processing layer sends traffic index to link manager, and link manager 305 finds the CPRI module 302, 303, or 304 that supports capacity and latency requirements of that traffic index. Link managers use the traffic index sent by the upper layer in order to find what type of traffic will be sent over fronthaul connection.

The primary issue with CRAN 102 or 203 is the fronthaul link's 103, 104, 105, or 205 capacities. As in FIG. 1, CRAN 102 serves more than one RRH 108, 109, and 111. There should be sufficient fronthaul capacity to send and to receive all the data. Also, certain traffic types have latency requirements, which means, data should be sent with a pre-defined maximum delay value. Fronthaul link should also satisfy data transmission latency requirements.

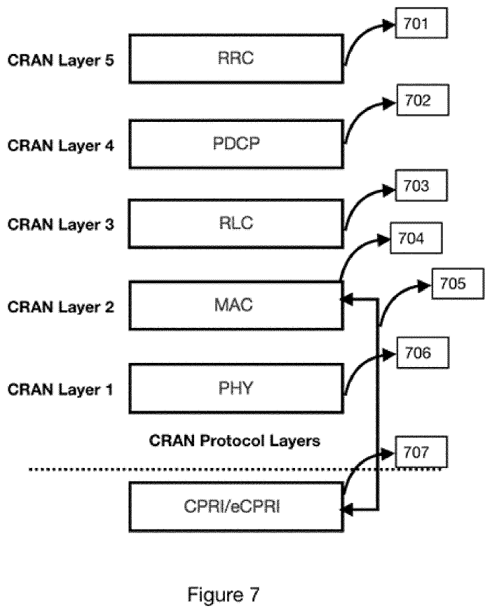

An embodiment of the invention is directed to a dynamic method of processing CPRI layer functions 401, 402, 403, 404, 405, 406, 407, 408, and 409, shown in FIG. 7, which are based on available CPRI fronthaul link 103, 104, and 105, or 205 capacity and fronthaul link data transmission latency. In current implementation of CPRI data transmission protocol data processing layers, three different layer split architectures are defined. Two layer split architectures are defined for downlink, and one layer split architecture is defined for uplink. According to an embodiment of the invention, any split at any data processing layer is possible, and any split is done based on the available CPRI capacity and latency of the CPRI link.

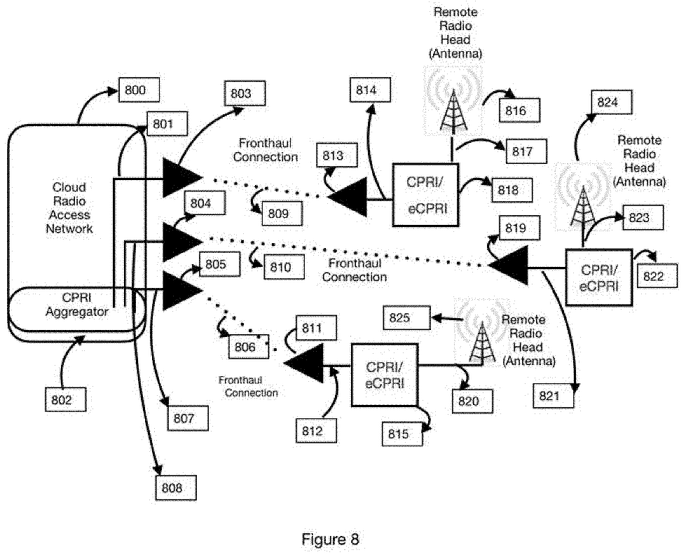

In an embodiment of the invention, as shown in FIG. 8 a CPRI repeater 903, eCPRI repeater 903, CPRI router 1004, eCPRI router 1004, and CPRI layer bridge 1103, eCPRI layer bridge 1103. Split, layer split, protocol split, protocol layer split, software protocol layer split, software layer split terms are the same, and these terms are used interchangeably in this disclosure.

Data transmission latency over the fronthaul link 103, 104, 105, and 205 is measured between two CPRI/eCPRI modules, where the default split model is no split model. As indicated in FIG. 7, if no split model is used, layer 1's, 409, of two CPRI/eCPRI modules communicate with each other. If data transmission latency over fronthaul link is more than a certain defined data transmission latency threshold (or data transmission delay bound) for the traffic type sent over CPRI/eCPRI, the sender CPRI/eCPRI moves one protocol layer up, which is layer 2, 408, and the output of layer 2, 408 is sent to receiving CPRI/eCPRI on the other side of the fronthaul link. Receiving CPRI/eCPRI receives layer 2, 408, data and uses this data as an input to its own layer 1, 409, to create the final version of the data in order to send it to remote radio head 108, 109, 111, 206, 505, 605, 816, 824, or 825, in FIGS. 1, 6, 11, and 2.

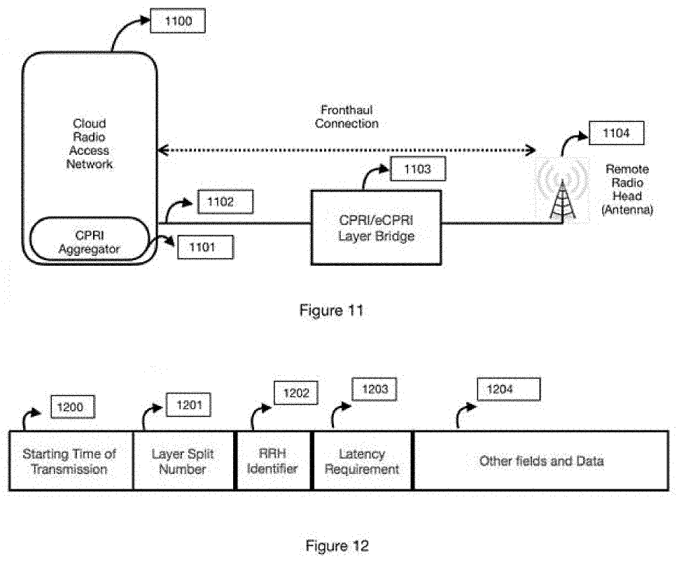

If a data transmission latency requirement is still not met, as indicated in FIG. 7, sender CPRI/eCPRI moves one more layer level up, layer 3, 407 and output of layer 3, 407, is sent to receiving CPRI/eCPRI 503 or 601, of FIGS. 11 and 12, respectively, over fronthaul link. Receiving CPRI/eCPRI 503, 601 receives layer 3 data, and uses this data as an input to its own layer 2 to create the final version of the data in order to send it to remote radio head. The higher the layer, the less capacity is needed on the fronthaul link. Therefore, if the fronthaul link capacity is lower than a pre-defined threshold, the sending side of CPRI/eCPRI will move up one or more layers to send data. The higher the layer, the less processing is done, and the less time spent to send the same from sending CPRI/eCPRI to receiving CPRI/eCPRI.

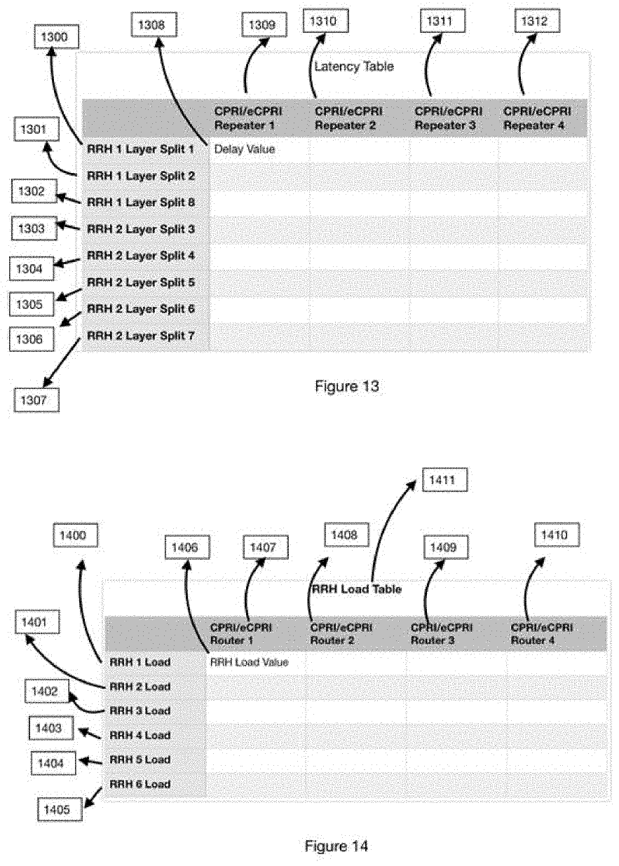

FIG. 13 shows CRAN processing layers and where CPRI/eCPRI layer falls into the CRAN architecture. There is direct communication between CPRI/eCPRI layer 707 and MAC layer 704 in order to determine at least one of quality of service class, throughput requirements, delay requirements, bit error rate requirements, block error rate requirements, antenna requirements, beam forming requirements, or synchronization requirements.

FIG. 8 shows CPRI/eCPRI repeater 903, and CPRI/eCPRI repeater 903 can be placed anywhere in the fronthaul. One CPRI repeater serves at least one remote radio head, and also one CPRI/eCPRI repeater 903 serves at least one CRAN. CPRI/eCPRI repeater 903 measures the latency of the incoming packet, and also reads data transmission latency requirements from the received packet itself. CPRI/eCPRI repeater 903 also measures the average delay between itself and with all remote radio heads it is connected to. CPRI/eCPRI repeater 903 also knows the processing time of each remote radio heads at each CPRI/eCPRI protocol layer. If the packet delay of the received packet is already equal to the delay requirement, higher than delay requirement, or higher than a delay threshold, the CPRI/eCPRI repeater 903 will not send the packet to RRH since at the time it will be delivered to RRH, the packet will fail to satisfy the latency requirement, and, potentially, will be dropped. When dropped, the CPRI/eCPRI repeater 903 will notify the CPRI/eCPRI sender 501 or 603, as shown in FIGS. 11 and 12, in CPRI/eCPRI aggregator 301, as shown in FIG. 3, to resend the same CPRI data/signal/data packet and eCPRI data packet.

A eCPRI packet, as shown in FIG. 14, has a Starting Time of Transmission 1200, Layer Split Number 1201, RRH Identifier 1202, and other required fields and eCPRI data 1204. Starting time of the transmission 1200 is the time that eCPRI data packet leaves the transmitter eCPRI. Layer Split Number 1201 shows which layer split 410, 411, 412, 413, 414, 415, 416, or 417, as shown in FIG. 7, where communication is taking place. FIG. 7 shows 9 layer levels that can be used to perform communication between eCPRI transceivers. Each eCPRI data packet can be created at a different processing layer level. RRH identifier 1202 defines which RRH the eCPRI packet is being sent.

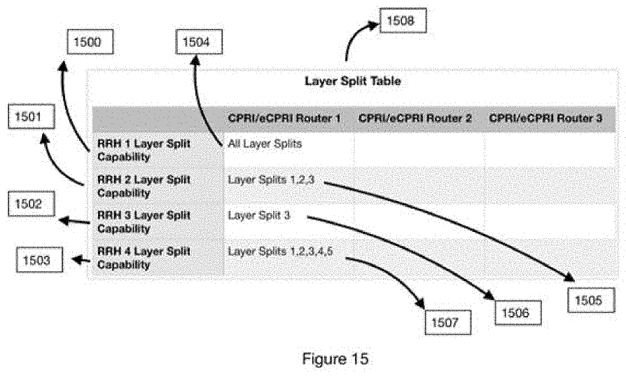

Each CPRI/eCPRI repeater 903 holds a layer latency table, FIG. 15. Latency table 1300 shows the data processing latency 1308 at each layer of the same and different RRHs or RRH 1300, 1301, 1302, 1303, 1304, 1305, 1306, and 1307 connected to CPRI/eCPRI Repeater 903, shown in FIG. 8. Once CPRI/eCPRI repeater 903 receives the packet from transmitter CPRI/eCPRI 501 or 603, the CPRI/eCPRI repeater 903 calculates delay(latency) value, where:

Delay(Latency)=(Data Transmission Start Time−Data Packet Arrival Time to CPRI Repeater)+(Receiving CPRI Layer Data Processing Time+Packet Transmission Time from CPRI/eCPRI Repeater 903 to targeted RRH).

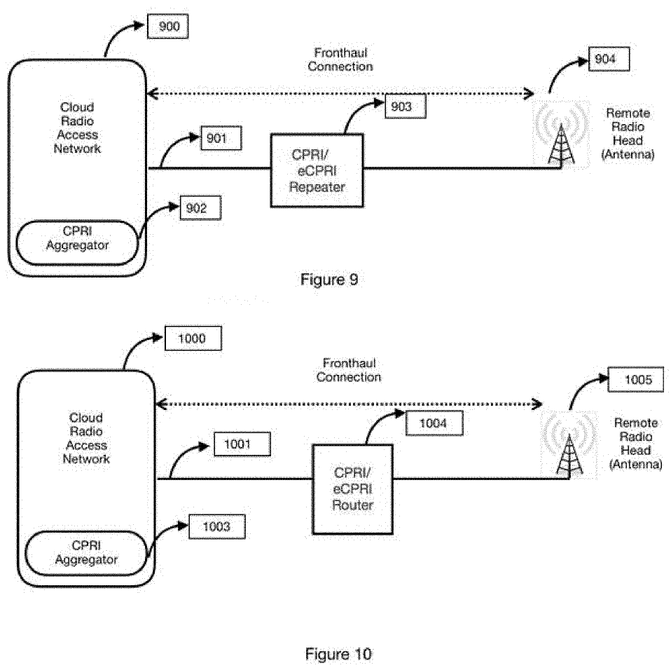

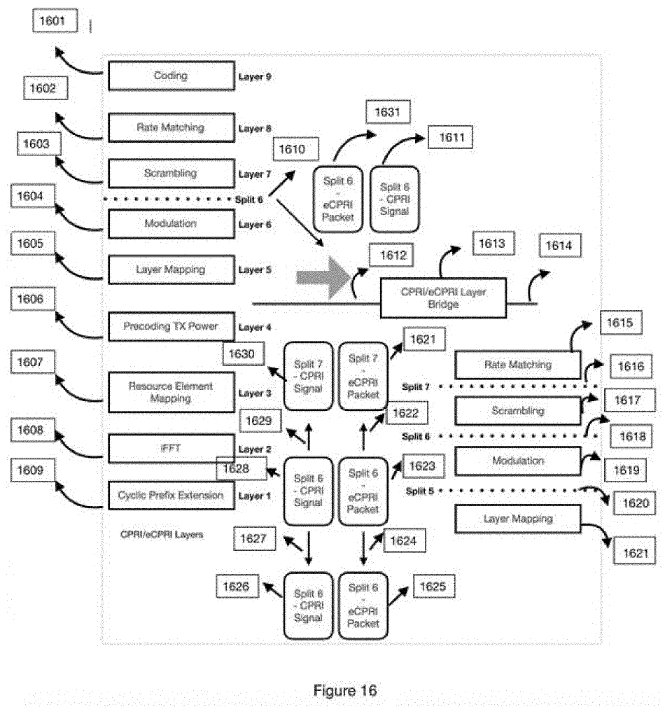

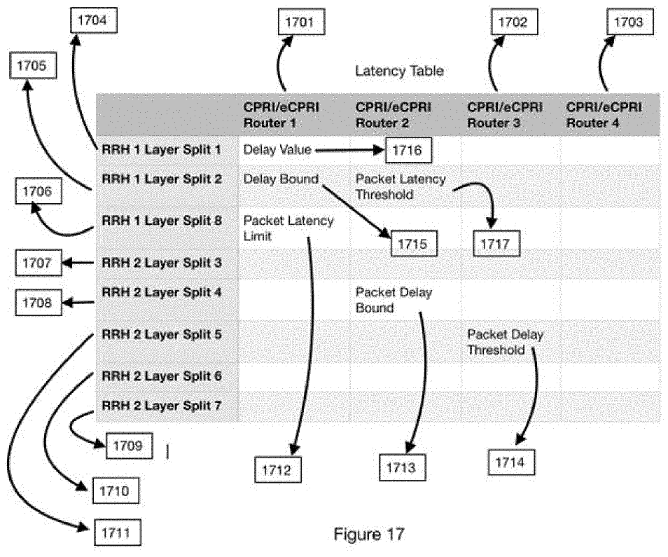

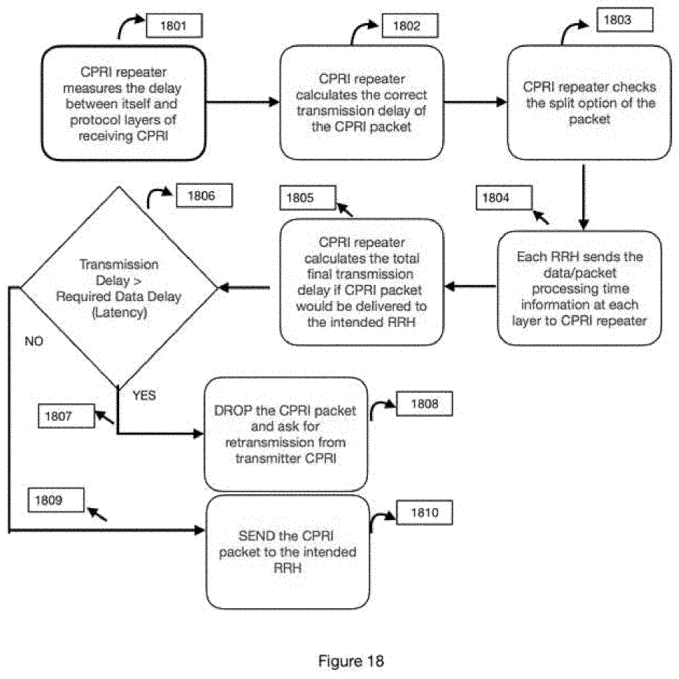

CPRI/eCPRI router 1004, as shown in FIG. 9, routes the packets to different directions in order to satisfy throughput and delay requirements for the CPRI signal and eCPRI data packet, respectively. CPRI/eCPRI router 1004 also holds a Latency table as does the CPRI/eCPRI repeater 903 shown in FIG. 8. CPRI/eCPRI router latency table is shown in FIG. 16. In addition to this table, CPRI/eCPRI router 1004 also holds a RRH load information table 1411, which shows the traffic load 1406 in the RRH 1400, 1401, 1402, 1403, 1404, and 1405, as shown in FIG. 17. CPRI/eCPRI 1004 router routes packets to less loaded RRHs.

CPRI Layer Bridge and eCPRI Layer Bridge 1103, as shown in FIG. 10, changes the layer split depending on the throughput and latency requirements of the CPRI signal and eCPRI data packet, respectively, for the RRH processing capability and RRH split capability 1504, 1505, 1506, and 1507. The CPRI/eCPRI layer bridge has the capability of changing the layer split of the received packet. CPRI/eCPRI layer bridge holds layer split table 1500, which shows the split capability of each RRH 1500, 1501, 1502, and 1503 connected to CPRI/eCPRI layer bridge. FIG. 17 shows an example of layer split table, eCPRI layer bridge performs layer split conversion between the different protocol layers shown in FIG. 7.

RRHs are classified into several different groups depending on the layer split model 1504, 1505, 1506, and 1507 they are supporting. “All split” model RRH supports layer split in all layers, for example. That means, “All Split” model RRH can receive and send CPRI/eCPRI data from any protocol level, or data processing block level. Once an RRH connects to CPRI/eCPRI Layer Bridge 1103, as shown in FIG. 10, RRH reports its capability by sending “split capability” message. Each RRH sends this “split capability” message in order to inform CPRI/eCPRI Layer Bridge 1103, of which layer splits RRH supports, or which layer split RRH supports. For example, one RRH sends “split capability” message as “Split 2,3”, which means that RRH supports protocol split in data processing layers of split 2, 416 and split 3, 415. If an RRH sends “split capability” message as “split 5” only, then that RRH supports split 5, 413.

Split conversion, layer split conversion, protocol layer split conversion, and data processing layer split conversion are equivalent terms, and it is the process of changing the data processing layer from which data is sent. In other words, output of a different protocol layer, or data processing layer, is used; or input to a different protocol layer or data processing layer is given. In this disclosure, a different protocol layer split is shown as ‘split x’ where ‘x’ means the split level in data processing layer, for example, as shown in FIG. 7. If split 2 is used, x=2 in ‘split x’ term.

A CPRI/eCPRI Layer Bridge 1103, as shown in FIG. 10, converts one version of CPRI/eCPRI layer split packet into another version of CPRI/eCPRI layer split packet. For example, if CPRI/eCPRI Layer Bridge 1103 receives CPRI/eCPRI split 6 packet, and if the RRH that this CPRI/eCPRI split 6 packet will be sent supports split 3 only, then CPRI/eCPRI Layer Bridge 1103 converts this packet into split 3 packet and sends this CPRI/eCPRI split 3 packet to the intended/targeted RRH.

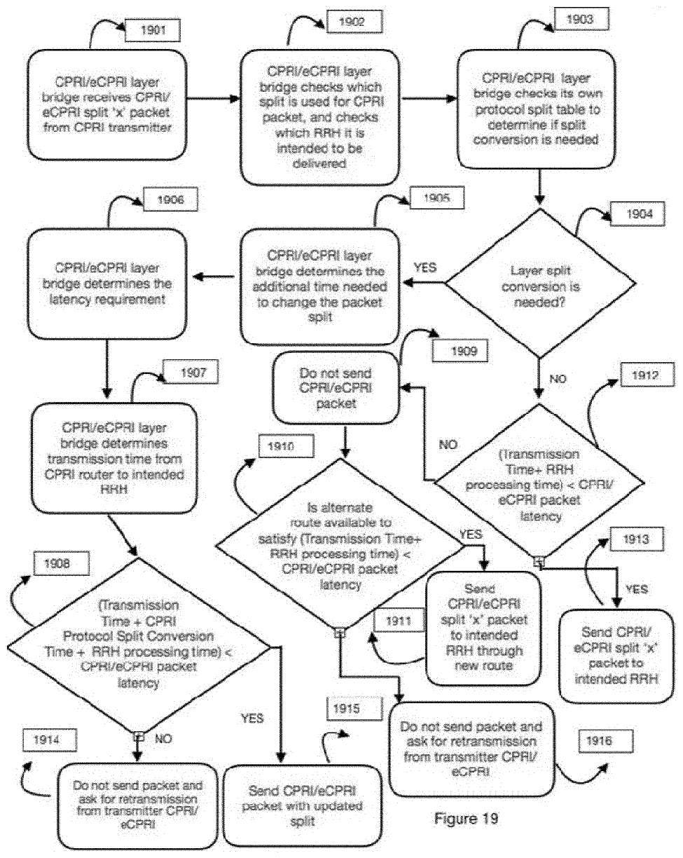

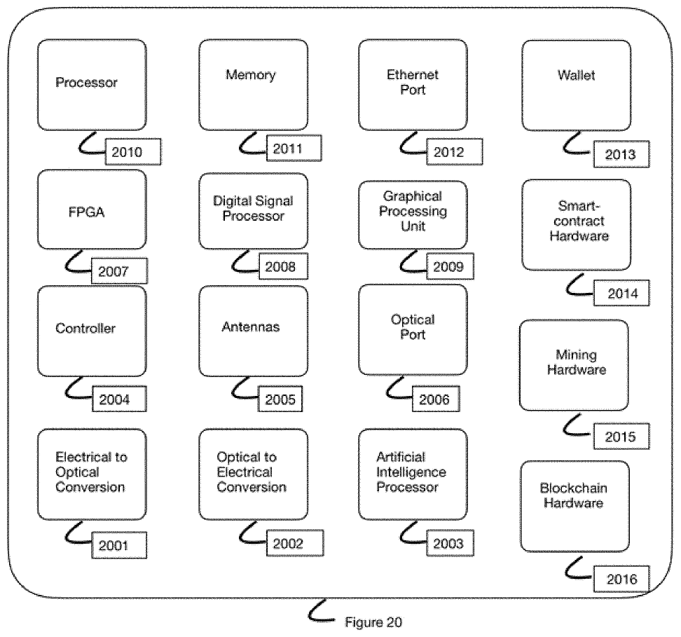

FIG. 19 shows the CPRI/eCPRI layer bridge method. A CPRI/eCPRI layer bridge receives a CPRI/eCPRI packet with split ‘x’ from CPRI/eCPRI transmitter, 1901. The CPRI/eCPRI layer bridge checks which split is used for CPRI packet, and checks which RRH it is intended to be delivered, 1902. The CPRI/eCPRI router checks its own protocol split table to determine if split conversion is needed, 1903. The CPRI/eCPRI layer bridge checks if data processing layer split conversion is needed, 1904, and there are different decisions at this point. If data processing layer split conversion is needed, CPRI/eCPRI layer bridge determines the additional time needed to change the packet split, 1905. CPRI/eCPRI layer bridge determines the latency requirement, 1906. The CPRI/eCPRI layer bridge calculates and determines transmission time from CPRI/eCPRI layer bridge to intended RRH, 1907. Intended RRH means the RRH that a CPRI/eCPRI data packet, signal is being sent to. Intended RRH further means RRH that receives CPRI/eCPRI packet, signal sent from sender. CPRI/eCPRI layer bridge calculates at step 1908 using the comparison equation:

(Transmission Time+CPRI/eCPRI Protocol Split Conversion Time+RRH processing time)<(CPRI/eCPRI data packet latency requirement.

If the condition of the comparison equation is true, the CPRI/eCPRI layer bridge sends/transmits a CPRI/eCPRI packet to intended RRH with updated data processing layer split, 1915. The condition of the comparison equation is false, the CPRI/eCPRI layer bridge drops the packet, does not transmit the packet, and ask for retransmission from the sender, 1914. If data processing layer split conversion is not needed, the CPRI/eCPRI router calculates and performs comparison at step 1912 by the equation:

(Transmission Time+RRH processing Time)<(CPRI/eCPRI data packet transmission delay).

When true, the CPRI/eCPRI router sends CPRI/eCPRI packet with split X to intended RRH, 1913. If false, the CPRI/eCPRI layer bridge does not send the CPRI/eCPRI packet data to intended RRH, 1909, and the CPRI/eCPRI layer bridge checks if alternate data transmission route is available to satisfy the relationship, 1910:

(Transmission Time+RRH processing Time)<(CPRI/eCPRI data packet transmission delay)

If there is an alternate data transmission route, CPRI/eCPRI layer bridge sends CPRI/eCPRI data packet through this new data transmission route, 1911. If there is no alternate data transmission route, then CPRI/eCPRI router drops the packet, and CPRI/eCPRI layer bridge asks for the retransmission of the same packet from the source, 1916.

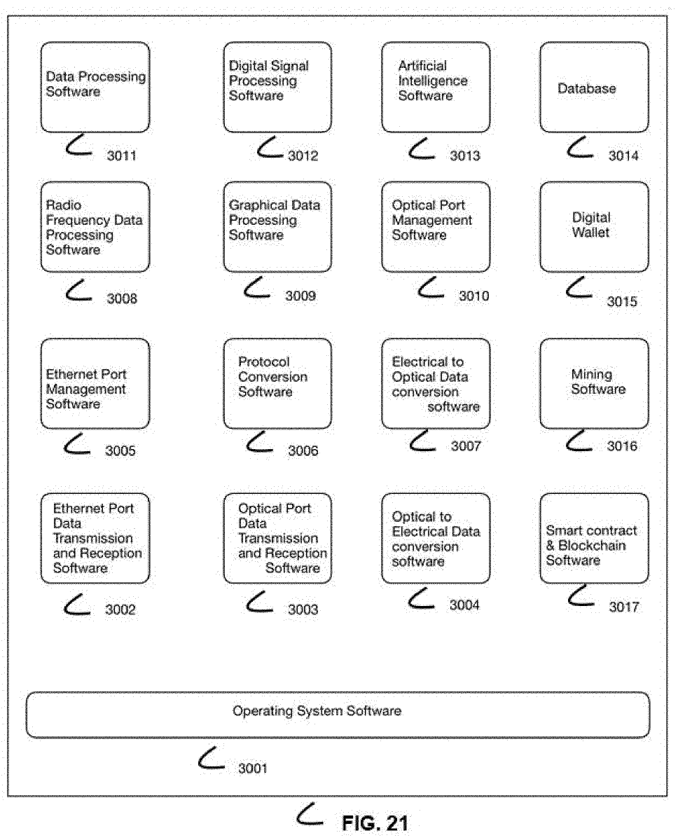

FIGS. 20 and 21 show CPRI/eCPRI router operation. In FIG. 20, CPRI/eCPRI router receives CPRI/eCPRI data packet with split ‘x’, 4001. CPRI/eCPRI router checks which data processing layer split is used for a CPRI/eCPRI data packet, and the CPRI/eCPRI router checks to which RRH this CPRI/eCPRI data packet is intended to be delivered, 4002. CPRI/eCPRI router checks its own latency table to determine CPRI/eCPRI data packet transmission latency, 4003. CPRI/eCPRI router calculates at step 4004 the formula:

(Delay Value+RRH data processing time)<CPRI/eCPRI packet latency requirement)

If the relationship is true, the CPRI/eCPRI router transmits/sends CPRI/eCPRI data packet with the same split to intended RRH, 4006. If the relationship is false, the CPRI/eCPRI router checks if there is another data transmission route to satisfy CPRI/eCPRI packet delay requirement, 4005. If there is an alternate data transmission route available, CPRI/eCPRI router changes the CPRI/eCPRI transmission route to the new data transmission route to satisfy data transmission delay, 4007. If there is no alternate data transmission route available to satisfy the CPRI/eCPRI data packet delay requirement, the CPRI/eCPRI router checks the RRH load table to determine RRHs with available processing capability to successfully process CPRI/eCPRI data packet with split ‘x’, 4008. The CPRI/eCPRI router checks the layer split table to determine the best RRH to transmit CPRI/eCPRI data packet, 4009. The CPRI/eCPRI router changes CPRI/eCPRI data packet split to satisfy data transmission latency.

FIG. 21 shows a CPRI/eCPRI router CPRI/eCPRI data packet processing method. The CPRI/eCPRI router receives CPRI/eCPRI data packet with split ‘x’, 5001. The CPRI/eCPRI router checks which split is used for CPRI/eCPRI data packet, and checks which RRH it is intended to be delivered, or intended to be sent, 5002. CPRI/eCPRI router checks RRH load, split capability, transmission link data capacity, 5003. CPRI/eCPRI router changes transmission link, or CPRI/eCPRI data transmission link, or CPRI/eCPRI data transmission route to a route that satisfies CPRI/eCPRI data packet capacity requirement, 5004. CPRI/eCPRI router transmits CPRI/eCPRI data packet to RRH with available CPRI/eCPRI data processing capacity, 5005. CPRI/eCPRI router transmits CPRI/eCPRI data packet to RRH supporting CPRI/eCPRI packet split.

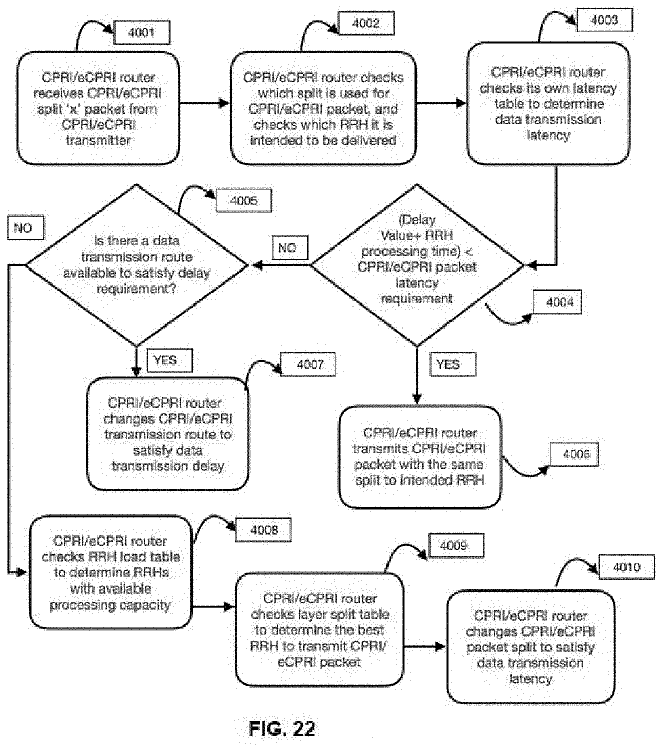

FIG. 22 shows CPRI/eCPRI repeater, 6004, between RRHs, 6008, 6009, 6010, 6011, and 6013 and Cloud Radio Access Networks, 6001, 6002, and 6012. CPRI/eCPRI repeater, 6004, is placed on the fronthaul link, 6006. CPRI/eCPRI repeater, 6004, transmits CPRI/eCPRI data packets from at least one of Cloud Radio Access Networks to at least one of RRHs. CPRI/eCPRI repeater, 6004, transmits CPRI/eCPRI data packets among RRHs. CPRI/eCPRI repeater, 6004, transmits CPRI/eCPRI data packet from one RRH to at least one of RRHs. CPRI/eCPRI repeater, 6004, transmits packets from one highly loaded RRH to another less loaded RRH. CPRI/eCPRI repeater, 6004, transmits packets from at least one of highly loaded RRH to at least one of less loaded RRH. CPRI/eCPRI data packets are sent to any direction by CPRI/eCPRI repeater. CPRI/eCPRI data packets are sent to any direction by RRH. CPRI/eCPRI data packets are sent to any direction by Cloud Radio Access Network.

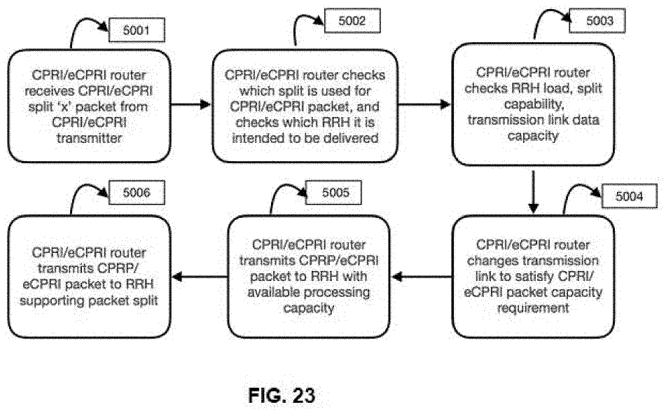

FIG. 23 shows CPRI/eCPRI router, 7004 between RRHs, 7005, 7006, 7007, 7008, and 7009 and Cloud Radio Access Networks. CPRI/eCPRI router, 7004 is placed on the fronthaul link, 7010. CPRI/eCPRI router, 7004, transmits CPRI/eCPRI data packets from at least one of RRHs, 7005, 7006, 7007, 7008, and 7009 to at least one of Cloud Radio Access Network. CPRI/eCPRI router transmits CPRI/eCPRI data packets from at least one of Cloud Radio Access Networks, 7001, 7002, and 7003, to at least one of RRHs. CPRI/eCPRI router transmits packets from at least one of RRHs to at least one of other RRHs. CPRI/eCPRI transmits CPRI/eCPRI data packets from at least one of Cloud Radio Access Network to at least one of Cloud Radio Access Network. CPRI/eCPRI router transmits CPRI/eCPRI data packets depending on fronthaul link capacity to different RRHs. CPRI/eCPRI router transmits CPRI/eCPRI data packets to Cloud Radio Access networks depending fronthaul link capacity. CPRI/eCPRI router transmits CPRI/eCPRI data packets to Cloud Radio Access networks depending on fronthaul link latency. CPRI/eCPRI router transmits packets to Cloud Radio Access Networks depending on fronthaul link latency.

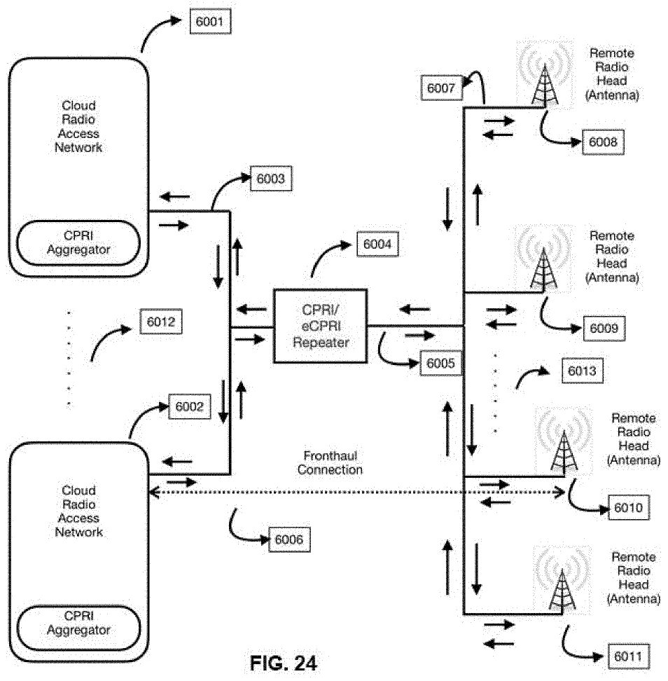

FIG. 24 shows CPRI/eCPRI layer bridge, 8004 between RRHs, 8006, 8007, 8008, 8009, and 8010 and Cloud Radio Access Networks, 8001, 8002, and 8003. CPRI/eCPRI layer bridge, 8004 is placed on the fronthaul link, 8011. CPRI/eCPRI layer bridge, 8004, transmits CPRI/eCPRI data packets from at least one of RRHs, 8006, 8007, 8008, 8009, and 8010 to at least one of Cloud Radio Access Network. CPRI/eCPRI layer bridge, 8004 transmits CPRI/eCPRI data packets from at least one of Cloud Radio Access Networks, 8001, 8002, and 8003, to at least one of RRHs. CPRI/eCPRI layer bridge, 8004 transmits packets from at least one of RRHs to at least one of other RRHs. CPRI/eCPRI layer bridge, 8004 transmits CPRI/eCPRI data packets from at least one of Cloud Radio Access Network to at least one of Cloud Radio Access Network. CPRI/eCPRI layer bridge, 8004 transmits CPRI/eCPRI data packets depending on fronthaul link capacity to different RRHs. CPRI/eCPRI layer bridge, 8004, transmits CPRI/eCPRI data packets to Cloud Radio Access networks depending fronthaul link, 8011, capacity. CPRI/eCPRI layer bridge, 8004, transmits CPRI/eCPRI data packets to Cloud Radio Access networks depending on fronthaul link, 8011 latency. CPRI/eCPRI layer bridge, 8004 transmits packets to Cloud Radio Access Networks, 8001, 8002, 8003 depending on fronthaul link, 8011 latency.

CPRI/eCPRI router, CPRI/eCPRI repeater, CPRI/eCPRI layer bridge transmit CPRI/eCPRI data packet to at least one of RRHs coming from at least one of Cloud Radio Access Networks. At least one of RRHs transmits CPRI/eCPRI data packet to at least one of CPRI/eCPRI repeaters. At least one of RRHs transmits CPRI/eCPRI data packet to at least one of CPRI/eCPRI routers. At least one of RRHs transmits CPRI/eCPRI data packet to at least one of CPRI/eCPRI layer bridges. At least one of RRHs transmits data to at least one of RRHs through at least one of CPRI/eCPRI repeater. At least one of RRHs transmits data to at least one of RRHs through at least one of CPRI/eCPRI router. At least one of RRHs transmits data to at least one of RRHs through at least one of CPRI/eCPRI layer bridge.

CPRI/eCPRI router, CPRI/eCPRI repeater, CPRI/eCPRI layer bridge transmit CPRI/eCPRI data packet to at least one of RRHs coming from at least one of Cloud Radio Access Networks. At least one of RRHs transmits CPRI/eCPRI data packet to at least one of CPRI/eCPRI repeaters. At least one of RRHs transmits CPRI/eCPRI data packet to at least one of CPRI/eCPRI routers. At least one of RRHs transmits CPRI/eCPRI data packet to at least one of CPRI/eCPRI layer bridges. At least one of RRHs transmits data to at least one of RRHs through at least one of CPRI/eCPRI repeater. At least one of RRHs transmits data to at least one of RRHs through at least one of CPRI/eCPRI router. At least one of RRHs transmits data to at least one of RRHs through at least one of CPRI/eCPRI layer bridge.

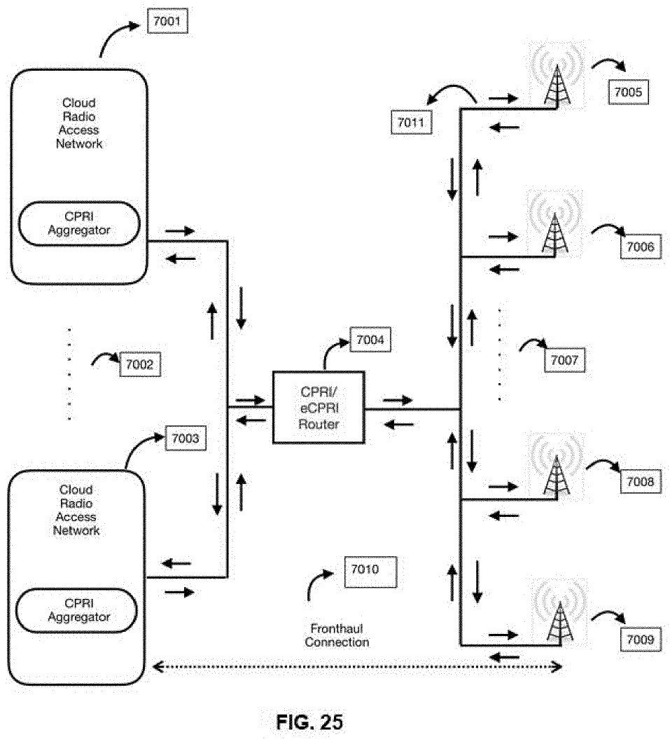

As illustrated in FIG. 25, CPRI/eCPRI repeater, 9004, 9005, and 9006 transmits CPRI/eCPRI data packet to at least one of RRHs coming from at least one of Cloud Radio Access Network, 9001, 9002, and 9003 using fronthaul connection, 9018. A Fronthaul link is a data communication link from cloud radio access network to RRH. At least one of RRHs 9007, 9008, 9009, and 9010 transmits CPRI/eCPRI data packet to at least one of CPRI/eCPRI repeater, 9004, 9005, and 9006. At least one of RRHs, 9007, 9008, 9009, and 9010 transmits CPRI/eCPRI data packet to at least one of CPRI/eCPRI repeater, 9004, 9005, and 9006. At least one of RRHs, 9007, 9008, 9009, and 9010 transmits CPRI/eCPRI data packet to at least one of CPRI/eCPRI repeater, 9004, 9005, and 9006. At least one of RRH, 9007, 9008, 9009, and 9010 transmits data to at least one of RRH, 9007, 9008, 9009, and 9010 through at least one of CPRI/eCPRI repeater, 9004, 9005, and 9006. At least one of RRH, 9007, 9008, 9009, and 9010 transmits data to at least one of RRH, 9007, 9008, 9009, and 9010 through at least one of CPRI/eCPRI repeater, 9004, 9005, and 9006. At least one of RRH, 9007, 9008, 9009, and 9010 transmits data to at least one of RRH, 9007, 9008, 9009, and 9010 through at least one of CPRI/eCPRI repeater. Fronthaul link is composed of a data communication link from cloud radio access network to CPRI/eCPRI repeater, 9011, 9012, 9019, and 9020, a data communication link from CPRI/eCPRI repeater to RRH, 9013, 9014, 9015, 9016, and 9017.

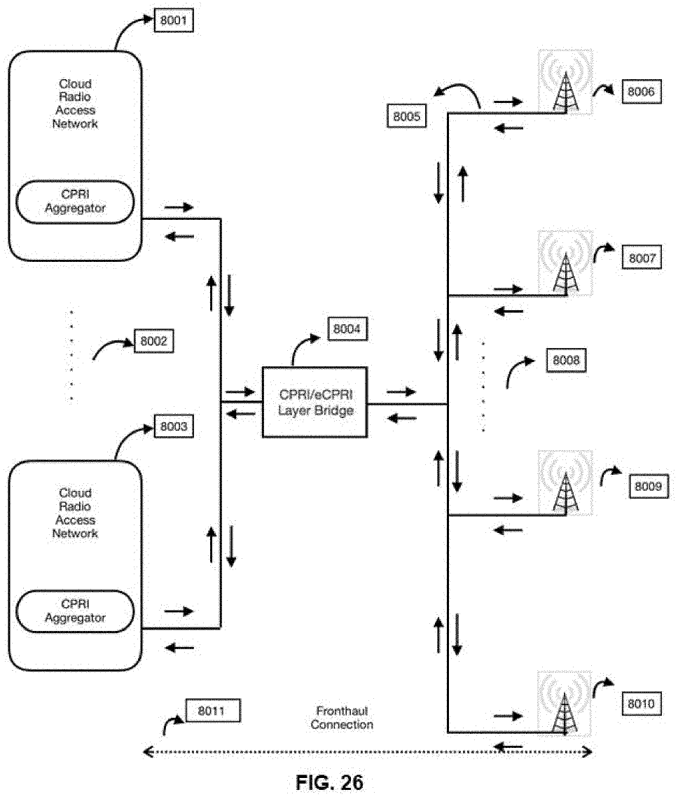

As illustrated in FIG. 26, CPRI/eCPRI router, 10006, 10008, 10009 transmits CPRI/eCPRI data packet to at least one of RRHs coming from at least one of Cloud Radio Access Network, 10000, 10001, 10002 using fronthaul connection, 10012. Fronthaul link is data communication link from cloud radio access network to RRH. At least one of RRHs 10003, 10013, 10014, and 10015 transmits CPRI/eCPRI data packet to at least one of CPRI/eCPRI router, 10006, 10008, and 10009. At least one of RRHs, 10003, 10013, 10014, 10015 transmits CPRI/eCPRI data packet to at least one of CPRI/eCPRI router, 10006, 10008, and 10009. At least one of RRHs, 10003, 10013, 10014, 10015 transmits CPRI/eCPRI data packet to at least one of CPRI/eCPRI router, 10006, 10008, and 10009. At least one of RRH, 10003, 10013, 10014, and 10015 transmits data to at least one of RRH, 10003, 10013, 10014, 10015 through at least one of CPRI/eCPRI router, 10006, 10008, and 10009. At least one of RRH, 10003, 10013, 10014, and 10015 transmits data to at least one of RRH, 10003, 10013, 10014, and 10015 through at least one of CPRI/eCPRI router, 10006, 10008, and 10009. At least one of RRH, 10003, 10013, 10014, and 10015 transmits data to at least one of RRH, 10003, 10013, 10014, and 10015 through at least one of CPRI/eCPRI router. Fronthaul link is composed of a data communication link from cloud radio access network to CPRI/eCPRI router, 10004, 10005, 10017, and 10018, a data communication link from CPRI/eCPRI router to RRH, 10007, 10017, 10010, 10011, and 10016.

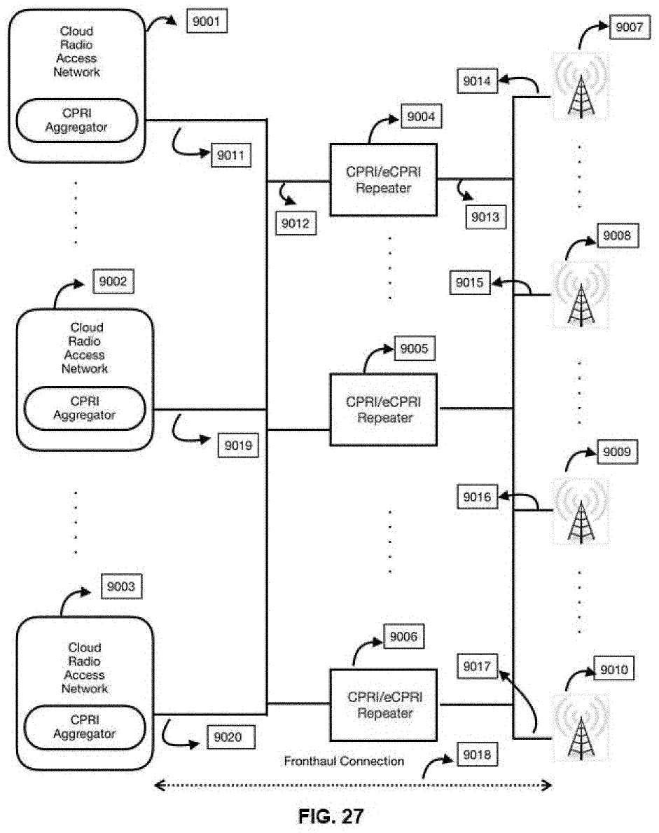

As illustrated in FIG. 27, CPRI/eCPRI layer bridge, 11007, 11008, and 11009 transmits CPRI/eCPRI data packet to at least one of RRHs coming from at least one of Cloud Radio Access Network, 11000, 11001, and 11002 using fronthaul connection, 11014. Fronthaul link is data communication link from cloud radio access network to RRH. At least one of RRHs 11010, 11011, 11012, and 11013 transmits CPRI/eCPRI data packet to at least one of CPRI/eCPRI layer bridge, 11007, 11008, and 11009. At least one of RRHs, 11010, 11011, 11012, and 11013 transmits CPRI/eCPRI data packet to at least one of CPRI/eCPRI layer bridge, 11007, 11008, and 11009. At least one of RRHs, 11010, 11011, 11012, and 11013 transmits CPRI/eCPRI data packet to at least one of CPRI/eCPRI layer bridge, 11007, 11008, and 11009. At least one of RRH, 11010, 11011, 11012, and 11013 transmits data to at least one of RRH, 11010, 11011, 11012, and 11013 through at least one of CPRI/eCPRI layer bridge, 11007, 11008, and 11009. At least one of RRH, 11010, 11011, 11012, and 11013 transmits data to at least one of RRH, 11010, 11011, 11012, and 11013 through at least one of CPRI/eCPRI layer bridge, 11007, 11008, and 11009. At least one of RRH, 11010, 11011, 11012, and 11013 transmits data to at least one of RRH, 11010, 11011, 11012, and 11013 through at least one of CPRI/eCPRI layer bridge, 11007, 11008, and 11009. Fronthaul link, 11014, is composed of a data communication link from cloud radio access network to CPRI/eCPRI layer bridge, 11003, 11004, 11015, 11016, and 11004 a data communication link from CPRI/eCPRI layer bridge to RRH, 11005, and 11006.

CPRI/eCPRI repeater, CPRI/eCPRI router, CPRI/eCPRI layer bridge records, data passing through them, transactions, information, messages, logs, traffic into a blockchain. CPRI/eCPRI repeater, CPRI/eCPRI router, CPRI/eCPRI layer bridge can mine any cryptocurrency. CPRI/eCPRI repeater, CPRI/eCPRI router, CPRI/eCPRI can sign smart contract among themselves. CPRI/eCPRI repeater, CPRI/eCPRI router, CPRI/eCPRI can sign smart contract among themselves and RRHs. RRHs can sign smart contract among themselves. CPRI/eCPRI repeater, CPRI/eCPRI router, CPRI/eCPRI can sign smart contract among cloud radio access networks. Cloud radio access network can sign smart contract among them. Cloud radio access network can sign smart contract with RRHs.

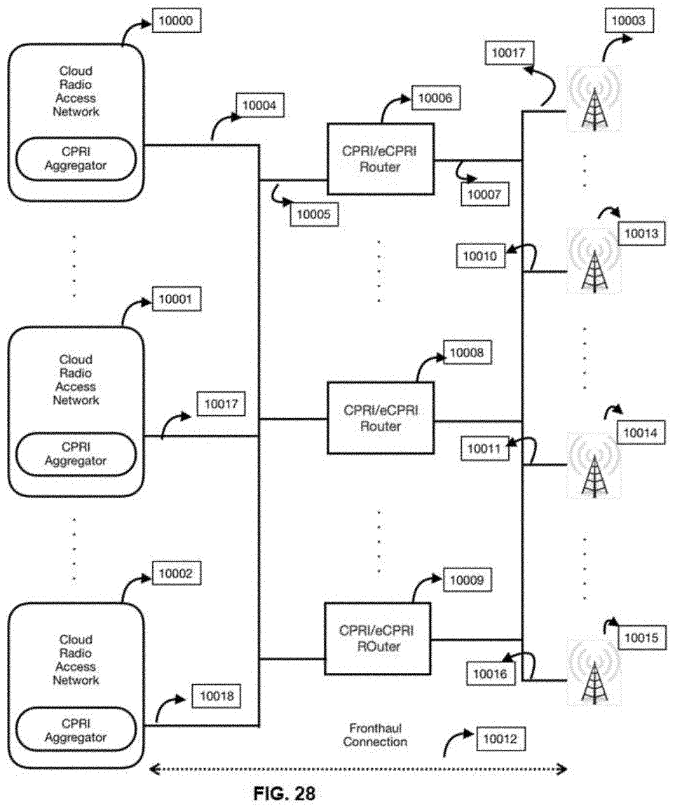

FIG. 28 shows RRH hardware. RRH hardware consists of at least one of processor, 12001, central processor unit (CPU), 12001, central processor, 12001, memory unit, 12002, field programmable gateway array (FPGA), 12005, ethernet port, 12013, digital signal processor, 12008, graphical processing unit (GPU), 12011, controller, 12007, antennas, 12006, optical port, 12004, electrical to optical conversion, 12014, optical to electrical conversion, 12009, artificial intelligence processor, 12010, mining hardware, 12005, database, 12003, RF circuit, 12012, and FPGA, 12015.

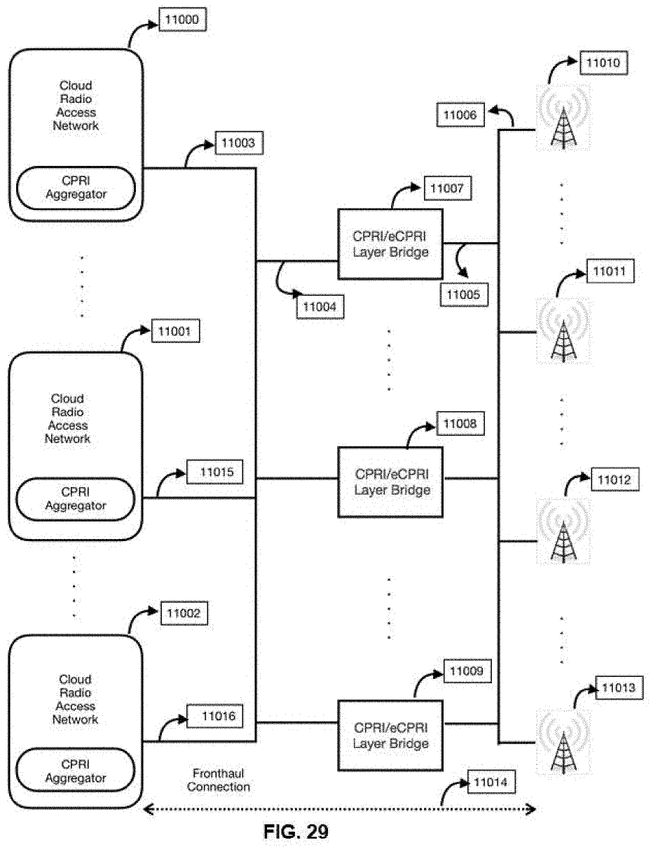

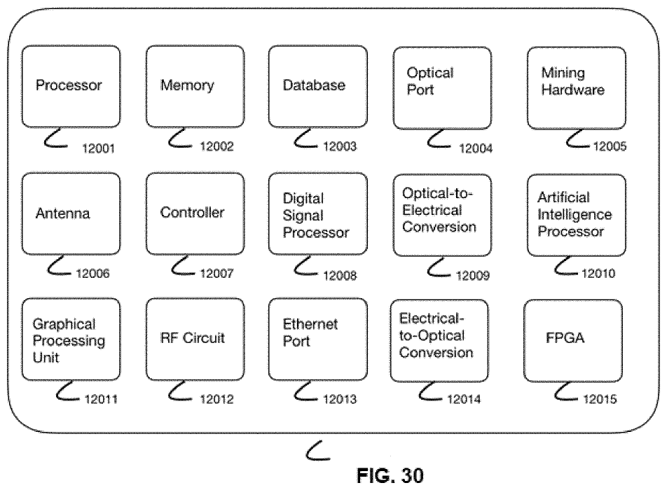

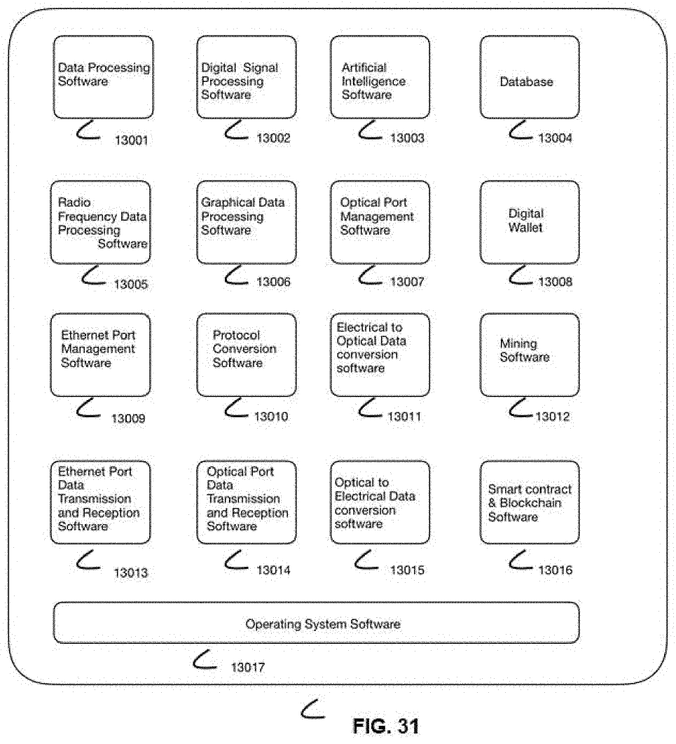

FIG. 29 shows RRH software. RRH software 13000, consists of at least data processing software, 13001, digital signal processing software, 13002, artificial intelligence software, 13003, database, 13004, radio frequency data processing software 13005, graphical data processing software, 13006, optical port management software, 13007, digital wallet software, 13008, ethernet port management software, 13009, protocol conversion software, 13010, electrical to optical data conversion software, 13011, mining software, 13012, ethernet port data transmission and reception software, 13013, optical data transmission and reception software, 13014, optical to electrical data conversion software, 13015, smart contract & blockchain software, 13016, and operation system software, 3017.

It should be understood that the examples and embodiments described herein are for illustrative purposes only and that various modifications or changes in light thereof will be suggested to persons skilled in the art and are to be included within the spirit and purview of this application.

I claim:

1. A method of communicating between a base band cloud unit and a plurality of remote radio heads, comprising the steps of:
transmitting a signal packet and a data packet from the base band cloud unit to at least one remote radio head through at least one digital radio interface;
sending an output of one of a least one layer of processing depending on a digital radio interface capacity and a digital radio interface latency performance;
sending the signal packet and the data packet from the base band cloud to at least one of the at least one remote radio heads through the digital radio interface with a digital radio interface repeater;
sending the signal packet and the data packet from the base band cloud to at least one of the at least one remote radio heads through the digital radio interface with the digital radio interface router; and
sending the signal packet and the data packet from the base band cloud to at least one of the at least one remote radio heads through the digital radio interface with the digital radio interface layer bridge, wherein the digital radio interface is at least one of a Common Public Radio Interface (“CPRI”) and an Ethernet Common Public Radio Interface (“eCPRI”), wherein the signal packet is Common Public Radio Interface (“CPRI”) signal packet, and wherein the data packet is Ethernet Common Public Radio Interface (“eCPRI”) data packet.

2. The method according to claim 1, wherein sending the output of different layers of processing further comprises measuring at least one or a CPRI link capacity and an eCPRI link capacity, measuring a signal round trip delay of at least one of CPRI link and eCPRI link, and determining which of the output of different layers of processing is sent through the at least one of the CPRI interface and the eCPRI interface.

3. The method according to claim 2, wherein determining which of the output of the different layers of processing further comprises determining at which of the at least one layer of processing a split is performed for determining: which of the output of the at least one layer of processing is used as a final processing layer on a sender's side; how long the split is used; for which of the data packet the split is used; and for which of at least one user the split is used.

4. The method according to claim 1, further comprising measuring a latency of at least one of the CPRI signal packet and the eCPRI data packet with the digital radio interface repeater and where the digital radio interface repeater is a CPRI repeater, wherein if the signal round trip delay of at least one of the eCPRI data packet and the CPRI signal packet is higher than a dynamically determined threshold, the CPRI repeater drops at least one of the CPRI signal packet and eCPRI data packet and asks for retransmission of at least one of the CPRI signal packet and eCPRI data packet from the at least one of a CPRI signal packet sender and an eCPRI data packet sender.

5. The method according to claim 1, further comprising measuring a latency of at least one of the CPRI signal packet and the eCPRI data packet between the digital radio interface repeater and each of the at least one remote radio head connected to the digital radio interface repeater through any of a direct link and an indirect link, and wherein the digital radio interface repeater is a CPRI repeater.

6. The method according to claim 1, wherein the eCPRI data packet comprises data selected from a Starting Time of Transmission, a Layer Split Number, a Remote Radio Head Identifier, and an eCPRI data.

7. The method according to claim 1, further comprises sending at least one of CPRI signal packet and eCPRI data packet through at least one of at least one transmission route wherein the transmission route used depends on a throughput requirement and a delay requirement of a carried traffic inside at least one of CPRI signal and eCPRI data packet, wherein sending is by the digital radio interface router and where the digital radio interface router is a CPRI router.

8. The method according to claim 1 wherein the digital radio interface router is a CPRI router that holds a latency (delay) table and a Remote Radio Head (RRH) load information table.

9. The method according to claim 8, wherein the digital radio interface repeater is a CPRI repeater or an eCPRI repeater and wherein the latency table further comprises conditions for the CPRI repeaters, the CPRI routers, the eCPRI repeaters, the eCPRI routers and the latency table comprises at least one latency value between a split performed at one of the at least one layer of processing for each of the remote radio heads, of the CPRI repeaters, and of the eCPRI repeaters.

10. The method according to claim 8, wherein the remote radio head load information table further comprises information concerning the CPRI routers, the eCPRI routers, the remote radio heads, and the load information of the remote radio head connected to one of the at least one CPRI router and at least one eCPRI router.

11. The method according to claim 1, further comprising changing where a split is performed between the at least one layer of processing for an incoming of at least one of the CPRI signal packet and the eCPRI data packet in the digital radio interface layer bridge depending on a data capacity (throughput), a data latency of at least one of CPRI link and eCPRI link, a remote radio head processing capability, a remote radio head split capability, wherein the digital radio interface is the CPRI interface or the eCPRI interface.

12. The method according to claim 1 wherein the digital radio interface layer bridge holds a layer split table and wherein the digital radio interface is the CPRI interface or the eCPRI interface.

13. The method according to claim 12 wherein the layer split table comprises information of at least one of a CPRI router and an eCPRI router, and a layer split capability of the remote radio heads.

14. A method of communicating between a base band cloud unit and a plurality of remote radio heads where at least one of a CPRI signal/data packet and an eCPRI signal/data packet are sent through at least one of a CPRI repeater and an eCPRI repeater, comprising:
measures at least one of a signal packet latency and a data packet latency or a delay between at least one of the CPRI repeater and the eCPRI repeater and one of at least one of a data processing layer and a signal processing layer of at least one of a receiving CPRI and a receiving eCPRI;
calculating a transmission delay of at least one of a CPRI signal/data packet and a eCPRI signal/data packet through the at least one of CPRI repeater and eCPRI repeater;
checking a split option of the at least one of the CPRI signal/data packet and the eCPRI signal/data packet for the at least one of the data processing layer and the signal processing layers through the at least one of CPRI repeater and eCPRI repeater;
sending signal and data processing time to each of at least one remote radio head connected to the at least one of CPRI repeater and eCPRI repeater at each of the at least one of the data processing layer and the signal processing layers;
calculating a total signal and packet data transmission delay for the at least one of the CPRI repeater and the eCPRI repeater if the CPRI signal/data packet or the eCPRI signal/data packet is delivered to the remote radio head;
dropping of the CPRI signal/data packet and the eCPRI signal/data packet and asking for retransmission of the CPRI signal/data packet and/or the eCPRI signal/data packet by the CPRI repeater and/or the eCPRI repeater if the total signal and data packet transmission delay (latency) is greater than a required data delay (latency); and
sending the CPRI signal/data packet and/or the eCPRI data packet from the at least one of the CPRI repeater and the eCPRI repeater to the remote radio head if the total signal and data packet transmission delay (latency) is less than or equal to the required data delay (latency).

15. A method of communicating between a base band cloud unit and a plurality of remote radio heads where a CPRI signal/data packet and an eCPRI packet are sent through a CPRI router and an eCPRI router, comprising:
determining which of a plurality of processing layer splits is used for the CPRI signal/data packet and the eCPRI data packet via the at least one of a CPRI router and a eCPRI router;
determining which of a plurality of processing layer splits is used for the CPRI signal/data packet and the eCPRI data packet to be delivered to one of at least one remote radio head;
checking a processing layer split table of the at least one of a CPRI router and a eCPRI router to determine whether the CPRI data packet and the eCPRI signal/data packet requires revision of the processing layer splits and a processing layer split conversion;
determining additional time required to change a CPRI signal/data packet conversion and an eCPRI data packet conversion via the at least one of a CPRI router and a eCPRI router;
comparing a sum of a transmission time and a remote radio head processing time with a CPRI signal/data packet latency requirement and an eCPRI data packet latency requirement to determine the requirement of the processing layer split;
transmitting the CPRI signal/data packet and/or the eCPRI signal/data packet by the CPRI router and the eCPRI router if the sum of transmission time and the remote radio head processing time is less than or equal to the CPRI signal/data packet latency requirement and the eCPRI data packet latency requirement when the processing layer split is not required;
dropping the CPRI signal/data packet and the eCPRI data packet by the CPRI router and/or the eCPRI router if the sum of transmission time and the remote radio head processing time is greater than the CPRI data packet latency requirement and the eCPRI data packet latency requirement when the processing layer split is not required;
determining an available alternate route that satisfy if the requirements of the sum of transmission time and the remote radio head processing time is less than, greater than, or equal to the CPRI signal/data packet and the eCPRI data packet transmission latency by the CPRI router and the eCPRI, wherein the CPRI signal/data packet and eCPRI data packet is transmitted to the remote radio head selected when the sum of the transmission time and the remote radio head processing time is less than or equal to the CPRI signal/data packet latency and the eCPRI data packet latency and drops the CPRI signal/data packet and eCPRI data packet when the sum of the transmission time and the remote radio head processing time is greater than the CPRI signal/data packet latency and/or the eCPRI data packet latency;
measuring the CPRI signal/data packet latency and the eCPRI data packet latency by the CPRI router and/or the eCPRI router that are transmitting and at least one of data processing layers and signal processing layers of a receiving CPRI and/or a receiving eCPRI depending on the processing layer splits;
determining the CPRI signal/data packet and the eCPRI data packet transmission time by the CPRI router and/or the eCPRI router to at least one of the remote radio heads connected to the CPRI router and the eCPRI router;
transmitting the CPRI signal/data packet and the eCPRI data packet by the CPRI and the eCPRI router if the sum of total of transmission time and a processing layer split conversion time and the remote radio head processing time is less than or equal to the CPRI signal/data packet latency and the eCPRI packet data transmission latency; and
dropping the CPRI signal/data packet and the eCPRI data packet by the CPRI and the eCPRI router when the sum of total of transmission time and the processing layer split conversion time and the remote radio head processing time is greater than the CPRI signal/data packet latency requirement and the eCPRI packet data latency requirement.
